(19) United States
(12) Patent Application Publication
(10) Pub. No.: US 2013/0279423 A1
(43) Pub. Date: Oct. 24, 2013

(54) APPARATUS AND METHOD FOR CONTROLLING COEXISTENCE INTERFERENCE WITHIN DEVICE IN WIRELESS COMMUNICATION SYSTEM

(71) Applicants: Jae Hyun Ahn, Seoul (KR); Ki Bum Kwon, Seoul (KR); Myung Cheul Jung, Seoul (KR)

(72) Inventors: Jae Hyun Ahn, Seoul (KR); Ki Bum Kwon, Seoul (KR); Myung Cheul Jung, Seoul (KR)

(73) Assignee: Pantech Co. ltd, Seoul (KR)

(21) Appl. No.: 13/978,506

(22) PCT Filed: Jan. 9, 2012
(86) PCT No.: PCT/KR2012/000145

§ 371 Date: Jul. 5, 2013

(30) Foreign Application Priority Data
Jan. 7, 2011 (KR) 1020110001741
Feb. 10, 2011 (KR) 1020110012058
Aug. 4, 2011 (KR) 1020110032873

(51) Int. Cl. H04W 24/02

(52) U.S. Cl. CPC H04W 24/02
USPC 370/328

(57) ABSTRACT

The present specification discloses the following steps: detecting a transmission from a first frequency band in a first network system causing interference on a reception in a second frequency band in a second network system; transmitting to a base station support information for supporting control of the interference that is detected; and receiving from the base station reply information for accepting or denying control of the interference that is detected, as a reply to the support information. The coexistence interference within the device can be detected, the resolving process thereof can be simplified and achievable, and reverse compatibility with other existing processes can be maintained.

### CROSS-REFERENCE TO RELATED APPLICATIONS

This application is the National Stage Entry of International Application PCT/KR2012/000145, filed on Jan. 9, 2012, and claims priority from and the benefit of Korean Patent Application No. 10-2011-0001741, filed on Jan. 7, 2011, Korean Application No. 10-2011-0012058, filed on Feb. 10, 2011, and Korean Application No. 10-2011-0032873, filed on Apr. 8, 2011, all of which are incorporated herein by reference for all purposes as if fully set forth herein.

### BACKGROUND

1. Field

The present invention relates to wireless communication and, more particularly, an apparatus and a method for coordinating in-device coexistence interference in a wireless communication system.

2. Discussion of the Background

A conventional wireless communication system uses a single frequency band for data transmission. For example, the second-generation wireless communication system uses bandwidth of 200 KHz to 1.25 MHz, whereas the third-generation wireless communication system uses bandwidth of 5 MHz to 10 MHz. To meet the demand for ever-increasing transmission capacity, the recent 3rd Generation Partnership Project (3GPP) Long Term Evolution (LTE) or IEEE 802.16m expands the bandwidth up to 20 MHz or more. Although it is essential to increase bandwidth to meet the demand for high transmission capacity, supporting high bandwidth even when quality of service required is low may incur large power consumption.

In this respect, multiple component carrier systems are now emerging, which define a carrier wave to use a predetermined frequency band and center frequency and support broadband data transmission and/or reception through a plurality of carrier waves. Both narrow and broadband data communication are supported by utilizing one or more carrier waves. For example, if a carrier wave corresponds to a bandwidth of 5 MHz, a maximum bandwidth of 20 MHz can be supported by using four carrier waves.

Due to ubiquitous access networks today, users at different places are able to access different networks and continue to maintain connectivity to the networks wherever they may be. In the prior art in which UE is allowed to communicate with only a single network system, the user has to carry different types of devices supporting the respective systems. As functions implemented in single UE are advanced and diversified these days, however, even single UE can perform communication with multiple network systems simultaneously and user's convenience is greatly enhanced.

However, in the case where single UE performs communication simultaneously through frequency bands of a plurality of network systems, in-device coexistence interference may occur. In-device coexistence interference refers to such kind of interference that causes interference caused by data transmission in a particular frequency band on another frequency band. For example, in case a single UE supports the Bluetooth and LTE (Long Term Evolution) system together, the in-device coexistence interference may be occurred between the frequency bands of the Bluetooth and the LTE system. The in-device coexistence interference usually occurs when separation between boundaries of frequency bands in a heterogeneous network system is not wide enough.

Frequency division multiplexing (FDM) may be used as a technique for avoiding in-device coexistence interference. In the FDM technique, in-device coexistence interference is controlled by avoiding a frequency band where in-device coexistence interference occurs. However, there still needs an agreement about a specific operating procedure between UE and an eNB for controlling in-device coexistence interference by using the FDM technique.

### SUMMARY

An object of the present invention is to provide an apparatus and method for controlling in-device coexistence interference.

Another object of the present invention is to provide an apparatus and method for detecting the occurrence of in-device coexistence interference.

Yet another object of the present invention is to provide an apparatus and method for transmitting information about in-device coexistence interference in a wireless communication system.

Still yet another object of the present invention is to provide an apparatus and method for coordinating in-device coexistence interference using frequency shift.

Further object of the present invention is to provide an apparatus and method for coordinating in-device coexistence interference using frequency shaping.

An additional object of the present invention is to provide an apparatus and method for coordinating in-device coexistence interference using an FDM technique.

According to one aspect of the present invention, there is provided an interference coordination method by user equipment in a wireless communication system. The method detecting interference, occurred by transmission in a first frequency band of a first network system, in receiving in a second frequency band of a second network system, sending assistance information, assisting coordination of the detected interference, to an eNB, and receiving response information which accepts or rejects the coordination of the detected interference, as a response to the assistance information from the eNB.

According to another aspect of the present invention, there is provided User equipment performing interference coordination in a wireless communication system. The user equipment includes an interference detection unit detecting interference occurred in receiving in a second frequency band of a second network system due to transmission in a first frequency band of a first network system, an assistance information generation unit generating assistance information assisting coordination of the detected interference, an assistance information transmission unit sending the assistance information to an eNB, and a response information reception unit receiving response information which accepts or rejects the coordination of the detected interference, from the eNB as a response to the assistance information.

According to yet another aspect of the present invention, there is provided a method of an eNB coordinating interference in user equipment by in a wireless communication system. The method includes receiving information about interference occurred in receiving in a second frequency band of a second network system due to transmission in a first frequency band of a first network system from the user equipment, determining whether or not to coordinate the interference based on the information, and sending response information which accepts or rejects the coordination of the interference, to the user equipment.

According to still another aspect of the present invention, there is provided an eNB performing interference coordination in a wireless communication system. The eNB includes an assistance information reception unit receiving assistance information that is information about interference occurred in reception in a second frequency band of a second network system due to transmission in a first frequency band of a first network system from user equipment, an interference coordination determination unit determining whether or not to coordinate the interference, a response information transmission unit sending response information which accepts or rejects the coordination of the interference, to the user equipment, and a scheduling unit performing scheduling on the coordination of the interference.

According to the present invention, in-device coexistence interference can be detected with ease; the process of resolving coexistence interference within the device can be simplified; and implementation thereof can be easily achieved and reverse compatibility with other existing processes can be maintained. Also, since information about in-device coexistence interference exchanged between UE and an eNB can be clearly defined, uncertainty in the procedure of controlling interference can be removed.

### BRIEF DESCRIPTION OF THE DRAWINGS

FIG. 1 illustrates a wireless communication system to which embodiments of the present invention are applied.

FIG. 2 illustrates in-device coexistence interference.

FIG. 3 is an example illustrating in-device coexistence interference acting on an LTE receiver from an ISM transmitter.

FIG. 4 illustrates a frequency band divided into the ISM band and the LTE band.

FIG. 5 illustrates one example in which in-device coexistence interference is relieved by employing the FDM technique.

FIG. 6 illustrates another example in which in-device coexistence interference is relieved by employing the FDM technique.

FIG. 7 illustrates one example in which in-device coexistence interference is mitigated by employing the TDM technique.

FIG. 8 illustrates transmit and receive timing in the time axis of the LTE and the ISM band employing the TDM technique.

FIG. 9 is a flow diagram illustrating a method for transmitting information about in-device coexistence interference according to one embodiment of the present invention.

FIGS. 10 and 11 illustrate a method for detecting in-device coexistence interference according to one example of the present invention.

FIGS. 12 to 14 illustrate a method for detecting in-device coexistence interference according to another example of the present invention.

FIGS. 15 to 17 illustrate a method for carrying out controlling in-device coexistence interference according to one example of the present invention by using frequency shift or shaping.

FIG. 18 is a flow diagram illustrating a method for transmitting information about in-device coexistence interference due to UE according to one example of the present invention.

FIG. 19 is a flow diagram illustrating a method for transmitting information about in-device coexistence interference due to an eNB according to one example of the present invention.

FIG. 20 is a block diagram illustrating an apparatus for transmitting information about in-device coexistence interference according to one example of the present invention.

### DETAILED DESCRIPTION OF THE ILLUSTRATED EMBODIMENTS

In what follows, part of the embodiments of the present document will be described in detail with reference to exemplary drawings. In assigning reference symbols to constituting elements in each drawing, it should be noted that the same symbols are assigned to the same constituting elements as possibly as can be even though they appear in different drawings. Also, in describing embodiments of the present invention, if it is determined that detailed description of a related structure or function known for those in the art obscures the technical principles of the present invention, the corresponding description will be omitted.

Also, in describing constituting elements of the present document, terms such as first, second, A, B, (a), (b), and the like can be used. Those terms are introduced only for the purpose of distinguishing a constituting element from the others; therefore, inherent characteristics, order, or sequence of the corresponding constituting element is not limited by the terms. If a particular constituting element is described to be “linked to”, “combined with”, or “connected to” a different constituting element, it should be understood that the constituting element can be directly linked or connected to the different constituting element but a third constituting element can also be “linked to”, “combined with”, or “connected to” the individual constituting elements.

Also, the present document is related to a wireless communication system; tasks performed in a wireless communication system can be carried out while a system controlling the corresponding wireless communication system (for example, an eNB) controls the network or transmits data or the tasks can be carried out in UE combined with the corresponding wireless network.

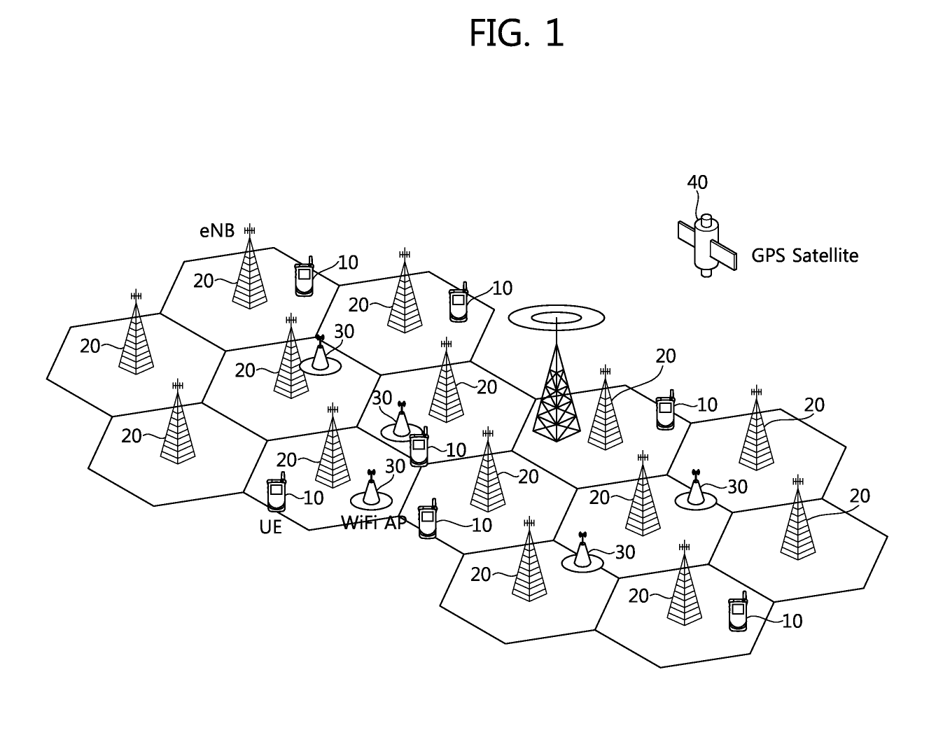

FIG. 1 illustrates a wireless communication system to which embodiments of the present invention are applied.

Referring to FIG. 1, a wireless communication system is widely deployed for providing various communication services such as voice, packet data, and so on; and comprises a user equipment (UE) 10, an eNB (evolved NodeB, eNodeB, eNB) 20, a wireless LAN access point (AP) 30, GPS (Global Positioning System) 40, and satellites. Here, wireless LAN refers to a device supporting the IEEE 802.11 technology, a wireless communication standard, and the IEEE 802.11 can be used interchangeably with the WiFi system.

The UE 10 can be located within a coverage formed by a plurality of networks such as a cellular network, wireless LAN, broadcast network, satellite network, and so on. The latest UE 10 is equipped with a plurality of wireless transceivers to connect to various services and networks such as an eNB 20, a wireless LAN access point 20, a GPS 40, and so on at anyplace and anytime. For example, a smart phone is equipped with an LTE, WiFi, and Bluetooth transceiver and a GPS receiver. In this respect, design of UE 10 is getting more complicated to ensure good performance and at the same time, to incorporate much more transceivers into the same UE 10. Therefore, this trend raises the possibility of the occurrence of in-device coexistence interference even larger.

In what follows, downlink transmission refers to communication from the eNB 20 to the UE 10 while uplink transmission refers to communication from the UE to the eNB 20. In the downlink transmission, a transmitter may be part of the eNB 20 while a receiver may be part of the UE 10. Similarly, in the uplink transmission, the transmitter may be part of the UE 10 while the receiver may be part of the eNB 20.

The UE 10 may be stationary or mobile and can be referred to by different terms such as a mobile station (MS), user terminal (UT), subscriber station (SS), mobile terminal (MT), wireless device, and the like. The eNB 20 refers to a fixed station communicating with the UE 10 and can be referred to by different terms such as a base station (BS), base transceiver system (BTS), access point, Femto BS, relay, and the like.

There is no limitation on the multiple access techniques used for a wireless communication system. Various multiple access techniques such as CDMA (Code Division Multiple Access), TDMA (Time Division Multiple Access), FDMA (Frequency Division Multiple Access), OFDMA (Orthogonal Frequency Division Multiple Access), SC-FDMA (Single Carrier-FDMA), OFDM-FDMA, OFDM-TDMA, and OFDM-CDMA can be used. For uplink and downlink transmission, a time division duplex (TDD) technique can be used, which carries out data transmission by using different time slots or a frequency division duplex (FDD) technique can be used, which carries out data transmission by using different frequency bands.

A Carrier aggregation (CA) supports a plurality of component carriers and is alternatively called spectrum aggregation or bandwidth aggregation. An individual carrier wave grouped together by carrier aggregation is called a component carrier (in what follows, it is called CC). Each CC is defined by its bandwidth and center frequency. Carrier aggregation is employed to support growing throughput, prevent increase of costs due to broadband RF (Radio Frequency) devices, and ensure compatibility with the existing systems. For example, if five CCs are allocated with granularity of 5 MHz bandwidth for each carrier, a maximum of 25 MHz bandwidth can be supported. In what follows, a multiple carrier system refers to the system supporting carrier aggregation. The wireless communication system of FIG. 1 can be a multiple carrier system.

According to carrier aggregation, frequency band of a system can comprise a plurality of carrier frequency. Here, carrier frequency refers to the center frequency of a cell. A cell denotes a downlink CC and an uplink CC. Similarly, a cell can denote a combination of a downlink CC and an optional uplink CC. Also, in the usual case where carrier aggregation is not considered, a single cell is constructed always in the form of a pair of a downlink and uplink CC.

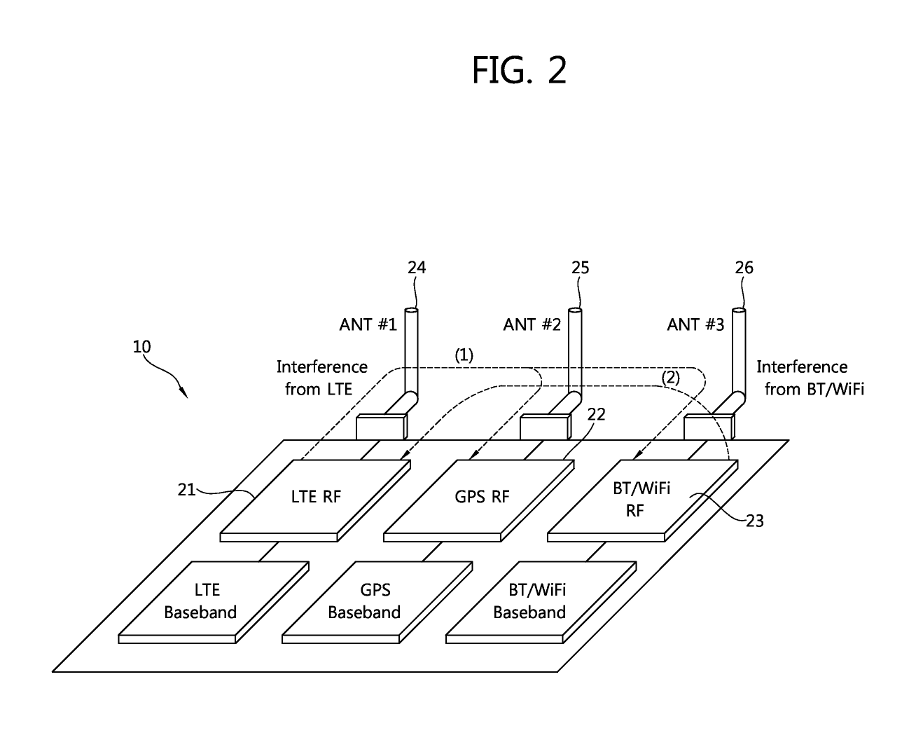

FIG. 2 illustrates in-device coexistence interference.

Referring to FIG. 2, the UE 10 comprises an LTE RF 21, GPS RF module 22, and Bluetooth/WiFi RF module 23. A transmit and receive antenna 24, 25, 26 is connected to each RF module. In other words, various types of RF modules are installed close to each other within a single device platform. At this time, transmission power of one RF module can be much larger than the reception power level onto other RF receivers. In this case, if frequency spacing between RF modules is not large enough and a sophisticated filtering technique is not available, a transmission signal from an arbitrary RF module can easily cause significant interference on the receivers of other RF modules within the same device. For example, (1) is an example in which a transmission signal of the LTE RF module 21 causes in-device coexistence interference on the GPS RF module 22 and the Bluetooth/WiFi RF module 23; and (2) is an example in which a transmission signal of the Bluetooth/WiFi RF module 23 causes in-device coexistence interference on the LTE RF module 21.

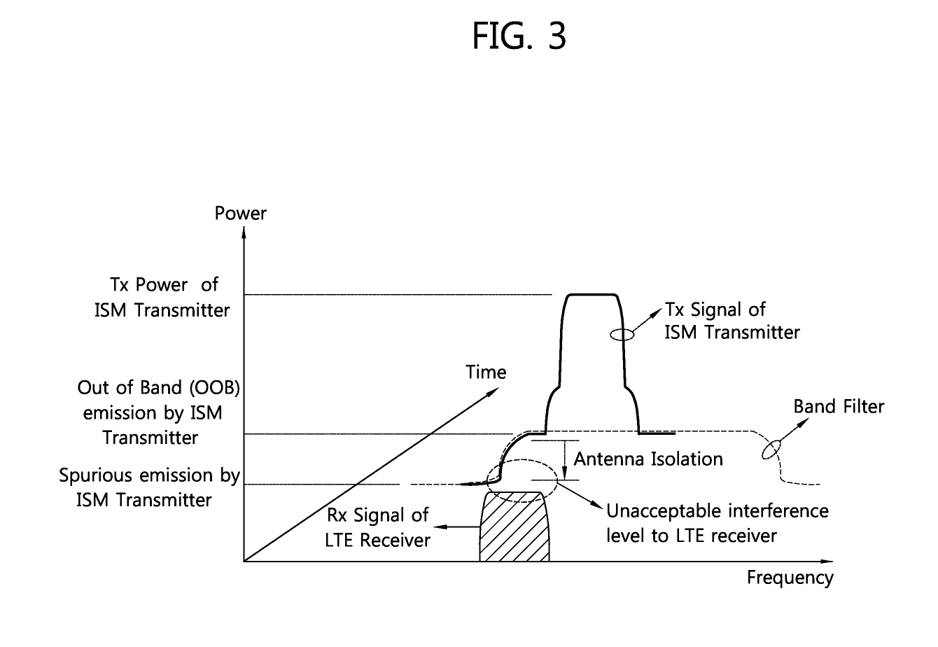

FIG. 3 is an example illustrating in-device coexistence interference acting on an LTE receiver from an ISM transmitter. ISM (Industrial, Scientific and Medical) band refers to the frequency bands that can be used freely without permission for industrial, scientific and medical purposes.

Referring to FIG. 3, the radio band of a signal received by the LTE receiver overlaps the radio band of a transmission signal of the ISM transmitter. In this case, in-device coexistence interference can be occurred.

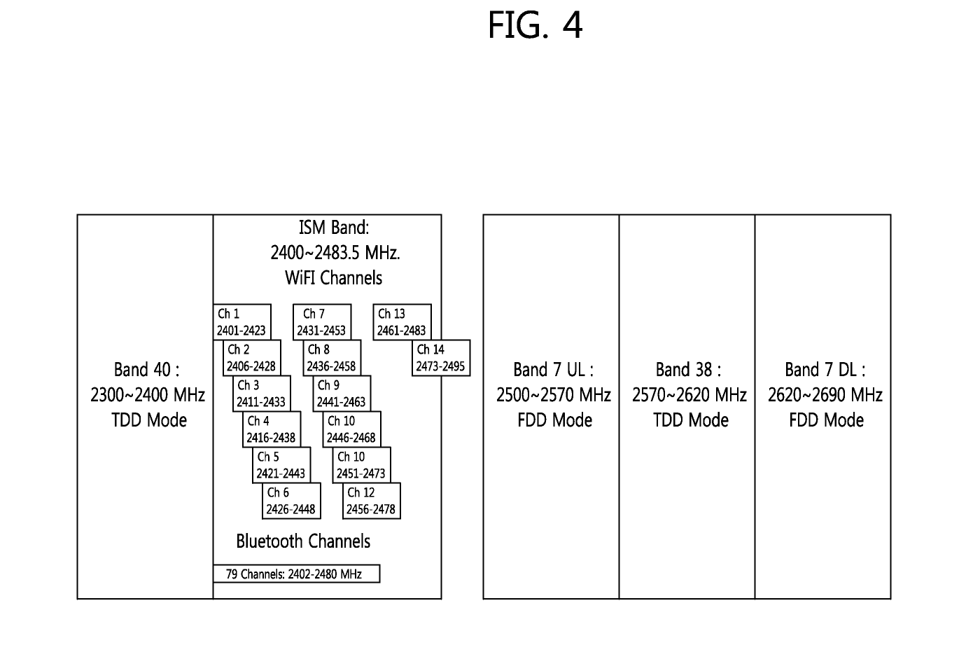

FIG. 4 illustrates a frequency band divided into the ISM band and the LTE band.

Referring to FIG. 4, radio band 40, 7, and 38 belong to the LTE band. The radio band 40 occupies the frequency range from 2300 to 2400 MHz in the TDD mode while the radio band 7 occupies the frequency range from 2500 to 2570 MHz as an uplink in the FDD mode. And the radio band 38 occupies the frequency range from 2570 to 2620 MHz in the TDD mode. Meanwhile, the ISM band is used for a WiFi channel and a Bluetooth channel and occupies the frequency range from 2400 to 2483.5 MHz. Here, in-device coexistence interference situations are summarized in the Table 1.

TABLE 1

| Interference band | Type of interference |
|---|---|
| Band 40 | ISM Tx → LTE TDD DL Rx |
| Band 40 | LTE TDD UL Tx → ISM Rx |
| Band 7 | LTE FDD UL Tx →ISM Rx |
| Band Jul. 13, 2014 | LTE FDD UL Tx → GPS Rx |

Referring to Table 1, the notation of ‘a→b’ representing type of interference indicates a situation where transmission of a causes in-device coexistence interference on reception of b. Therefore, in the radio band 40, transmission in the ISM band causes in-device coexistence interference on the TDD downlink reception (LTE TDD DL Rx) of the LTE band. Although a filtering scheme may somewhat alleviate the in-device coexistence interference, it is not sufficient. If FDM or TDM technique is applied in addition to the filtering scheme, in-device coexistence interference can be alleviated more efficiently.

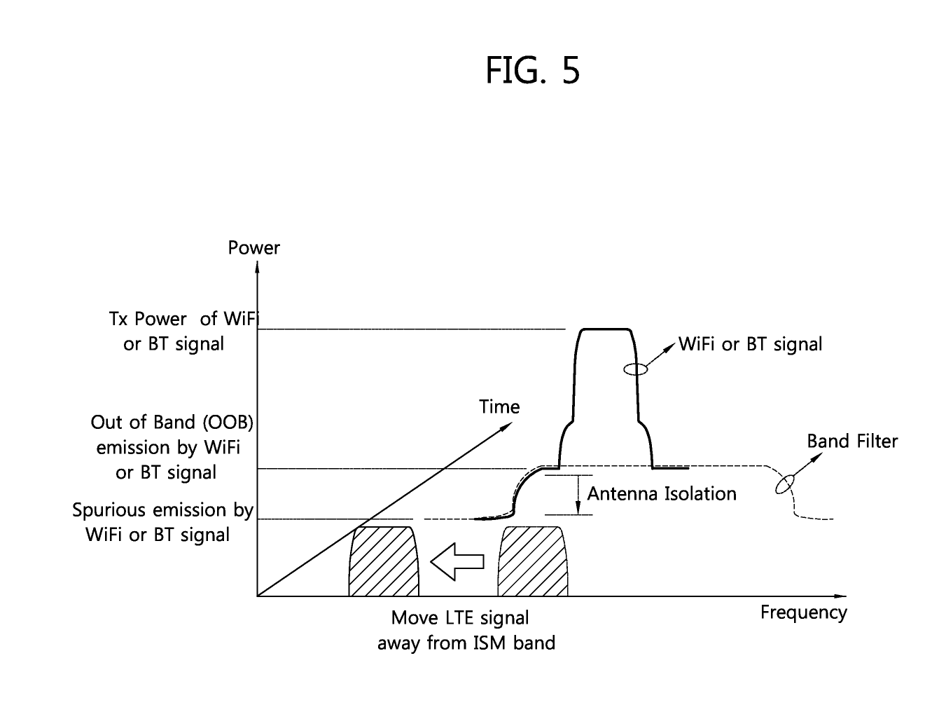

FIG. 5 illustrates one example in which in-device coexistence interference is relieved by employing the FDM technique.

Referring to FIG. 5, the LTE band can be shifted to avoid overlapping with the ISM band. And as a result, this introduces a handover of the UE from the ISM band. However, to this end, there needs a method for legacy measurement or new signaling to accurately triggering a mobility procedure or radio link failure (RLF) procedure.

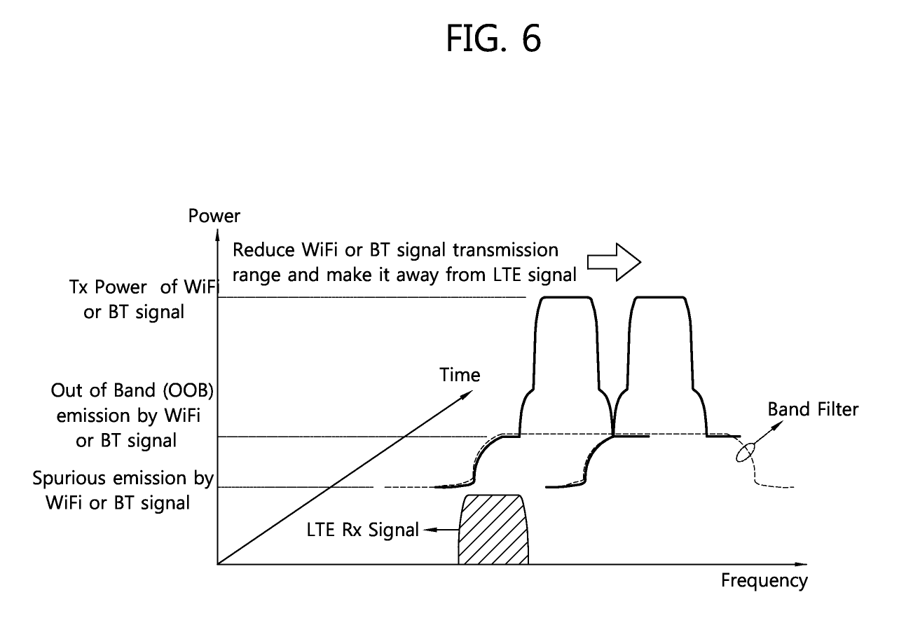

FIG. 6 illustrates another example in which in-device coexistence interference is relieved by employing the FDM technique.

Referring to FIG. 6, the ISM band can be reduced and moved away from the LTE band. However, this technique can cause a backward compatibility problem. In the case of Bluetooth, the backward compatibility problem can be somewhat relieved due to an adaptive frequency hopping mechanism but it may not be the case for WiFi.

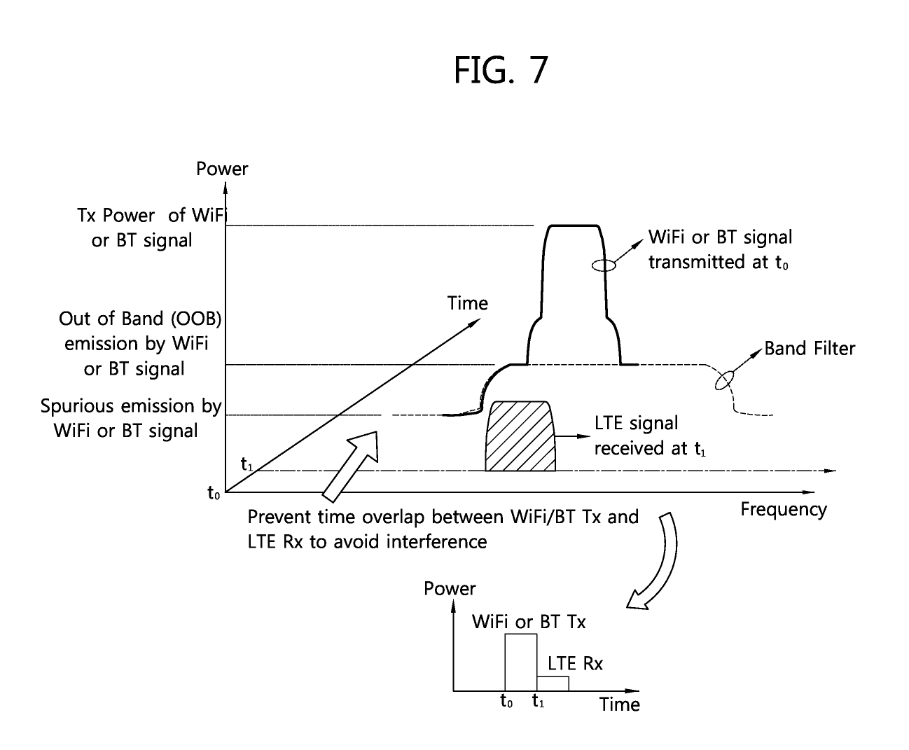

FIG. 7 illustrates one example in which in-device coexistence interference is mitigated by employing the TDM technique.

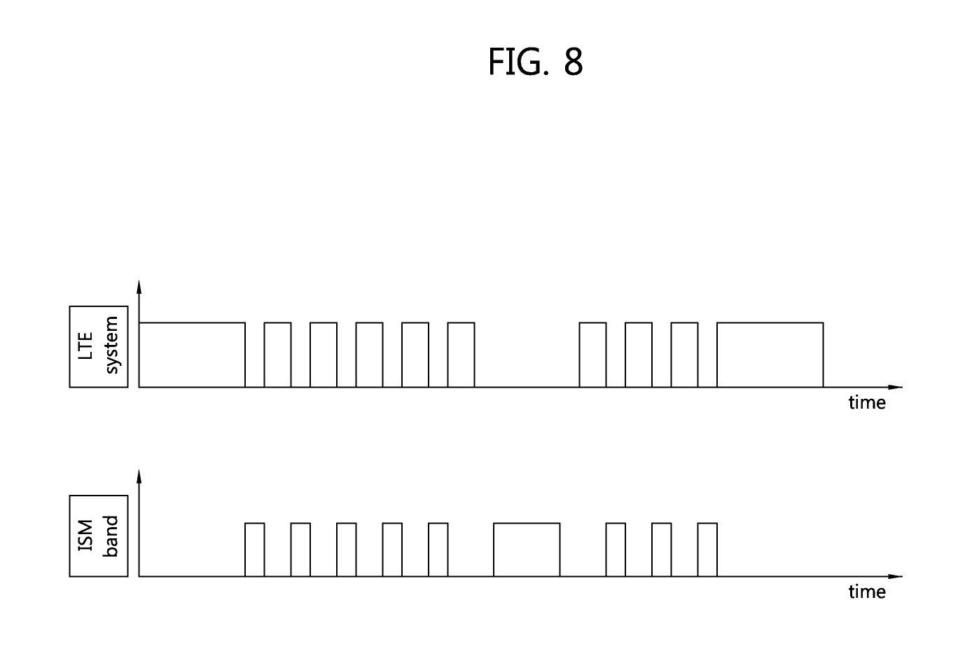

Referring to FIG. 7, if reception timing in the LTE band is made not to overlap with transmission timing in the ISM band, in-device coexistence interference can be avoided. For example, if a signal belonging to the ISM band is transmitted at time t₀, a signal belonging in the LTE band is made to be received at time t₁. In this way, a transmit and receive timing employing the TDM technique along the time axis for a signal in the LTE and ISM band can be represented as shown in FIG. 8.

Referring to FIG. 8, by adopting the scheme as described above, in-device coexistence interference can be avoided without incorporating band-to-band movement between the LTE and ISM band since the reception timing in the LTE band and transmission timing in the ISM band do not overlap with each other.

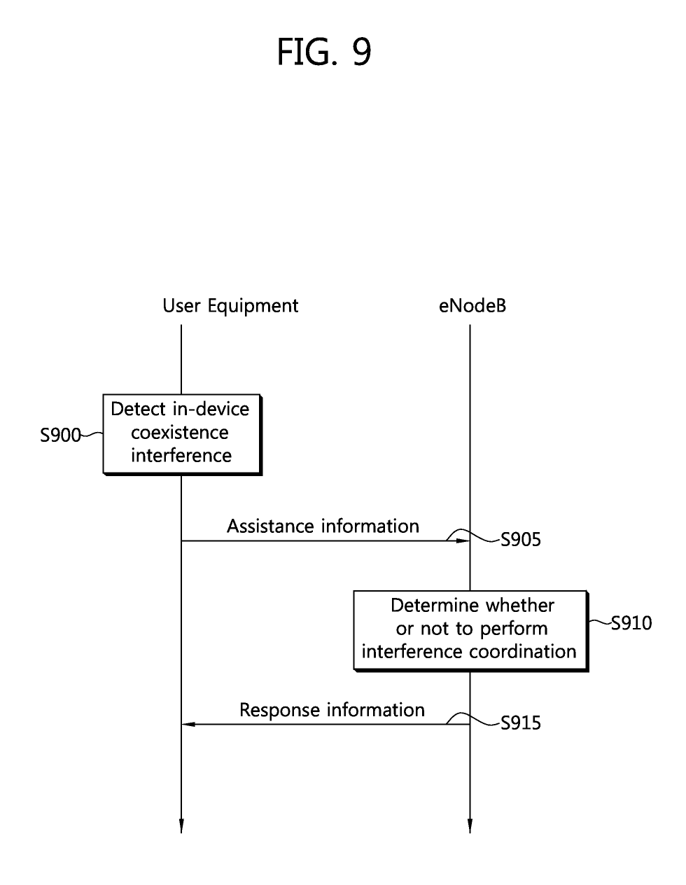

FIG. 9 is a flow diagram illustrating a method for transmitting information about in-device coexistence interference according to one embodiment of the present invention.

Referring to FIG. 9, the UE detects in-device coexistence interference S900. The in-device coexistence interference may correspond to a case where transmission from the UE to a nearby device communicating through Bluetooth or WiFi occurs interference on the reception of the UE from the eNB of the LTE system. In what follows, it is assumed that a signal y is transmitted through a different RF module such as a WiFi module while the UE is receiving a signal x from the eNB through the LTE RF module. In this situation, the UE detects whether a transmission signal from the different RF module generates interference on a reception signal of the LTE RF module.

As one example, the UE can detect in-device coexistence interference by using SINR (Signal to Interference Noise Ratio). If SINR of the signal y is larger than a predetermined threshold value and thus acts as interference on the signal x, the UE can detect occurrence of in-device coexistence interference.

As another example, the UE can detect in-device coexistence interference by using RSRP (Reference Signal Received Power) or RSRQ (Reference Signal Received Quality).

At this time, the UE, by defining a blank transmission area for transmission of the nearby device, can impose a constraint on the use of transmission resources of the nearby device. The blank transmission can be one example of the TDM technique. At this time, depending on a situation, a too much low transmission rate is allocated to the nearby device, making a service such as voice communication or streaming unavailable. In this case, if a frequency band available is generated irrespective of interference coordination based on the TDM technique, the UE may re-attempt interference coordination based on the FDM technique.

As another example, if a data transmission rate of the signal y becomes larger than a threshold value, the UE can detect in-device coexistence interference.

As a yet another example, if a state where strength of the signal y is larger than a predetermined threshold value lasts for a predetermined time period, the UE determines occurrence of in-device coexistence interference and detects the in-device coexistence interference.

As a still another example, if transmission of the signal y lasts for a predetermined time period, the UE may regard the transmission as existence of interference.

As a further example, if transmission of the signal y is repeated for more than a predetermined time period even though transmission of the signal y is not maintained, the UE determines existence of interference and detects the interference.

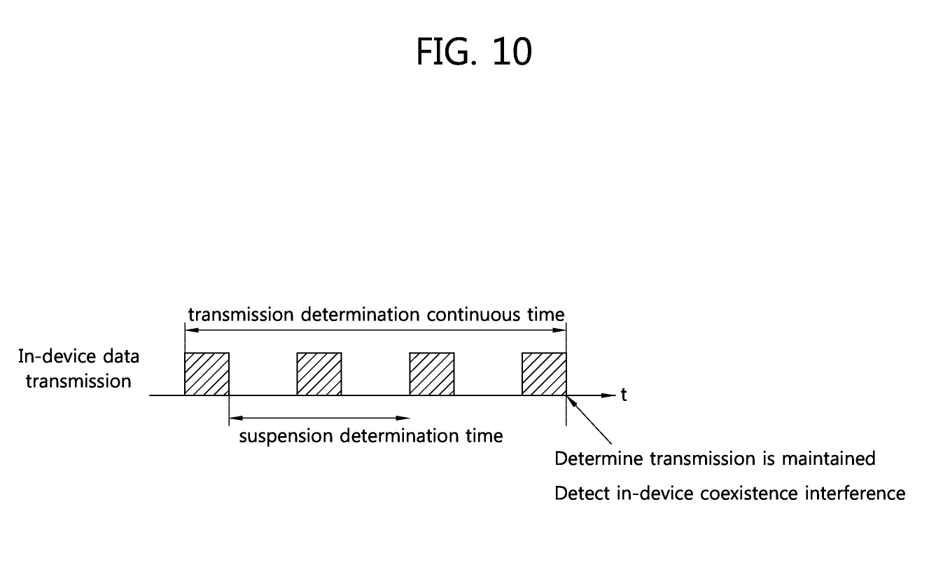

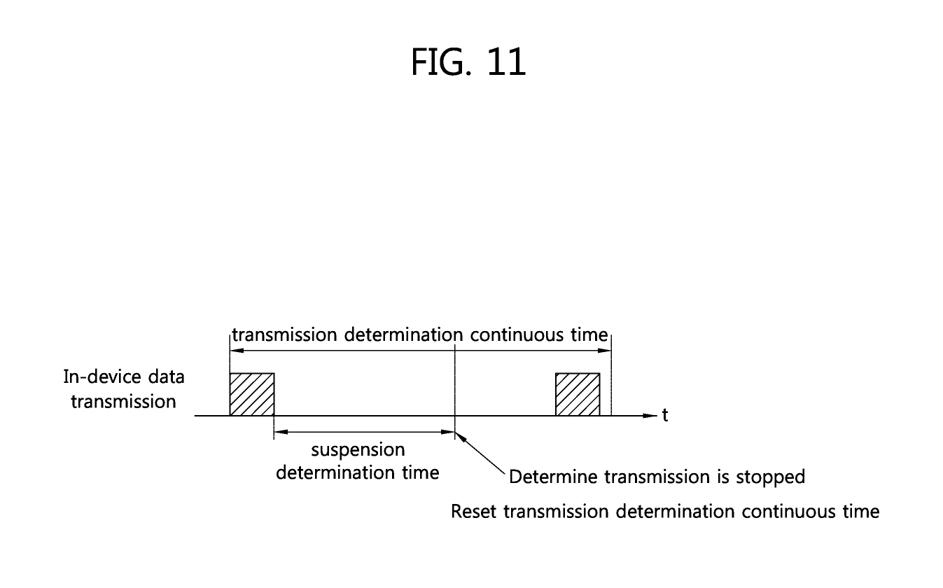

FIGS. 10 and 11 illustrate a method for detecting in-device coexistence interference according to one example of the present invention. The UE configures transmission determination continuous time and suspension determination time beforehand and by using them, detects in-device coexistence interference.

Referring to FIG. 10, if in-device data is transmitted within suspension determination time (which may be called a suspension determination duration) during transmission determination continuous time (which may be called a transmission determination duration), it is determined that transmission of a signal is maintained. If transmission of a signal is maintained during transmission determination continuous time, the UE detects in-device coexistence interference. In case a signal is transmitted again within predetermined time (suspension determination time of FIG. 10) even if transmission of a signal is not maintained but suspended for a while, the UE determines that transmission of the signal is maintained and detects co-existence interference.

Referring to FIG. 11, if data transmission is not carried out within suspension determination time during transmission determination continuous time, the UE does not detect in-device coexistence interference. This is because an unnecessary procedure is carried out if it is determined that there exists interference even when a signal has not been transmitted for a long time. Therefore, if the state where a signal is not transmitted lasts for more than suspension determination time, it is determined that transmission of the signal has been suspended. And transmission determination continuous time is reset. Afterwards, if a signal is newly transmitted, transmission determination continuous time proceeds again.

As another example, co-existence interference can be detected by using timers operating respectively for transmission determination continuous time or suspension determination time.

As another example, for the case where a signal u is transmitted to the eNB through another RF module such as the LTE RF or WiFi while the UE is receiving a signal z from the eNB through the ISM RF module, the method for detecting co-existence interference described above can be applied in the same manner. In-device coexistence interference can be detected from SINR and the in-device coexistence interference can be detected from RSRP or RSRQ. In case strength of interference of a measured signal u exceeds a predetermined threshold value or the state where the strength exceeds a predetermined threshold value lasts for a predetermined time period while a signal z is received through the ISM RF module, the UE determines occurrence of in-device coexistence interference and detects the interference. In this way, if it is determined that transmission of the LTE RF transmission hinders reception in the ISM band, the UE can detect coexistence interference.

Definition of data transmission as shown in FIGS. 10 and 11 can be defined as a state where strength of interference of the signal u becomes larger than a predetermined threshold value. On the contrary, in case strength of interference of a signal u drops below a predetermined threshold value, it can be defined as a state where transmission of data is suspended.

As another example, the UE can detect in-device coexistence interference based on strength of interference after filtering. Strength of in-device coexistence interference can correspond to the noise value against interference measured at a place receiving interference due to a different communication apparatus or the strength of interference itself. Since in-device coexistence interference may vary significantly depending on existence of data transmission to the different communication apparatus, it can be used for detection with reference to strength of interference after filtering that reduces the variation. The simplest example of filtering can be implemented as a weighted sum of strength of interference measured at each subframe. One example of weighted sum filtering can be expressed by the following mathematical equation.

Fₙ=(1−a)·Fₙ₋₁+a·Mₙ, [Equation 1]

where Fₙ is an interference value after filtering; Fₙ₋₁ is a previous interference value after filtering; Mₙ is an interference value measured at a current subframe; and a is a weight value. If strength of interference after filtering exceeds a predetermined threshold value, the UE can detect in-device coexistence interference.

As a yet another example, the UE can detect in-device coexistence interference with respect to the fact that strength of in-device coexistence interference lasts for a predetermined time period. In-device coexistence interference can be detected based on the condition that it lasts in a similar way to the data transmission of FIG. 10.

It should be noted, however that a difference from the method of FIG. 10 lies in the fact that the case where strength of interference at a particular subframe exceeds a predetermined threshold value can be regarded as an event such as data transmission. Suppose an event exceeding a threshold value is a strong interference occurring event while that drops below the threshold value a weak interference occurring event. Data transmission corresponds to a strong interference occurring event and an interval where data transmission is not performed corresponds to a weak interference occurring event. In terms of measurement samples, time can be interpreted by the number of samples.

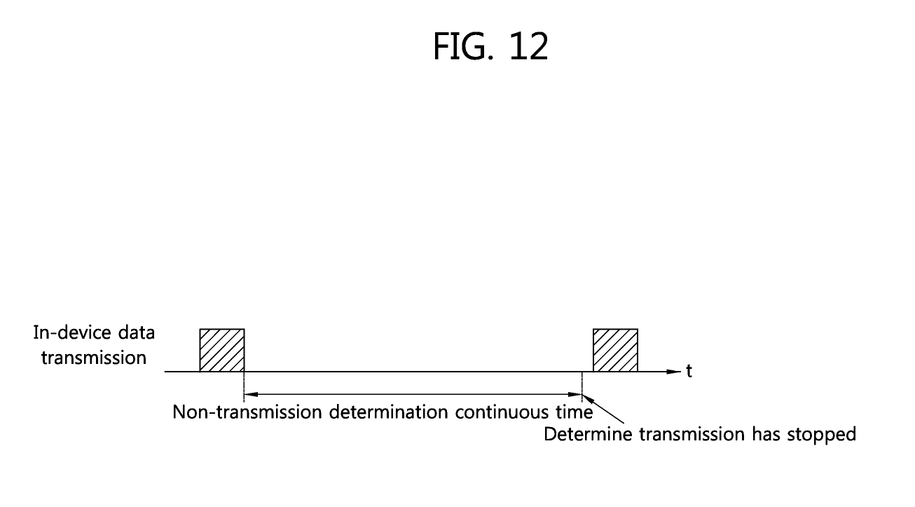

As a still another example, the UE can determine detection of in-device coexistence interference based on the fact that in-device coexistence interference is not detected for a predetermined time period as shown in FIGS. 12 to 14.

FIG. 12 illustrates a method for detecting in-device coexistence interference according to another example of the present invention. By using no-transmission determination continuous time (which can also be called “no-transmission determination duration”), no existence of co-existence interference is determined. No-transmission determination continuous time corresponds to the time period by which it is determined that no meaningful transmission causing co-existence interference is performed based on the condition that the state of no-transmission is kept for the corresponding amount of time period after transmission is terminated. This is different from the definition of transmission determination continuous time introduced above by which it is determined that meaningful data transmission causing co-existence interference has been performed based on the condition that data transmission lasts for the corresponding amount of time period since the data transmission is commenced.

Referring to FIG. 12, in case the UE transmits a signal y through a different RF module such as WiFi while receiving a signal x from the eNB through the LTE RF module, if transmission of a signal y is not carried out for the corresponding time duration, the UE determines that there is no co-existence interference. At this time, transmission of a signal y may imply data transmission itself or imply a situation where strength of interference measured at the LTE RF module is larger than a threshold value or SINR value measured at the LTE RF module is smaller than a threshold value.

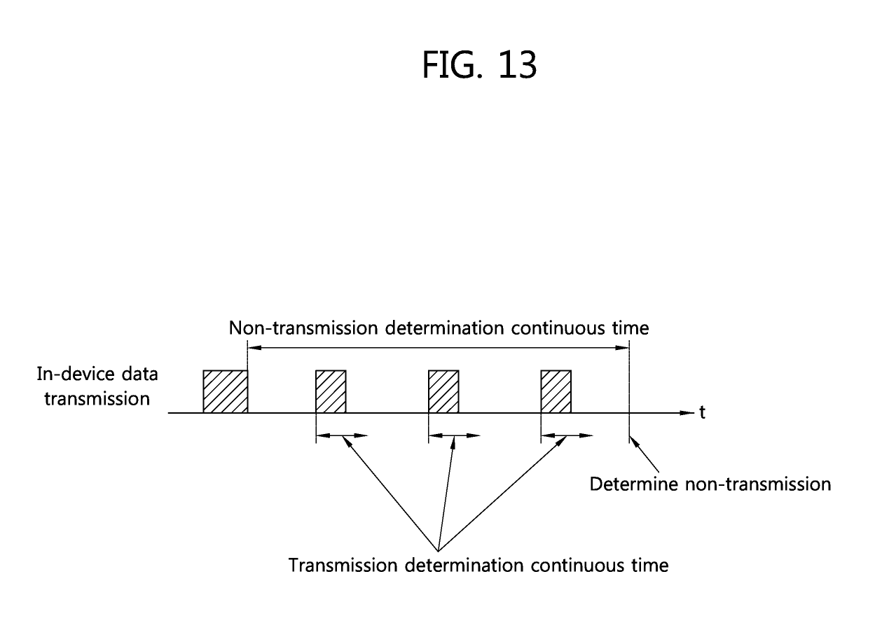

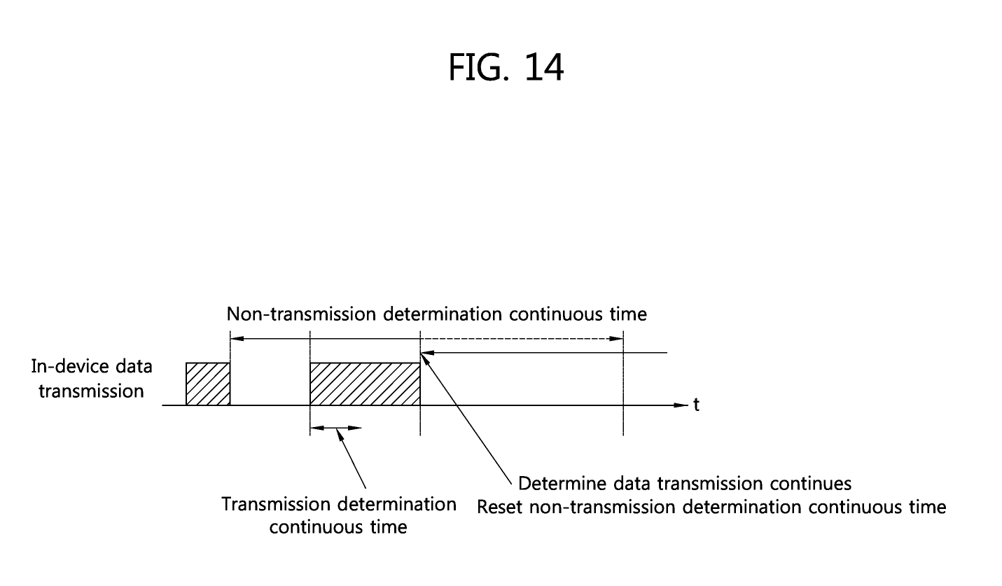

FIGS. 13 and 14 illustrate a method for detecting in-device coexistence interference according to another example of the present invention. Data transmission not lasting for a predetermined time period is regarded to be insufficient for occurring co-existence interference and therefore, it is not considered as co-existence interference. This is called “no transmission”. In case the situation where data transmission is not performed is maintained for no-transmission determination continuous time, the UE can determine that coexistence interference does not occur.

Referring to FIG. 13, if an interference signal is to be detected at all, the interference signal has to be transmitted for the transmission determination continuous time. In case a signal is detected for a time period less than the transmission determination continuous time, it is regarded that no data transmission is occurred. In case no signal is detected for the no-transmission determination continuous time, it is determined that no transmission is occurred and no interference signal has occurred. No transmission of a signal y may indicate non-occurrence of data transmission itself or the case where strength of interference measured at the LTE side is measured to be smaller than a threshold value or the case where SINR value is measured at the LTE side is larger than the threshold value.

Referring to FIG. 14, if a signal lasting for more than the transmission determination continuous time is detected before the no-transmission determination continuous time is completed, it is determined that data transmission is continued. Thus, since it is determined that an interference signal is generated, the UE detects in-device interference. Afterwards if transmission of a signal occurring co-existence interference is suspended again, the no-transmission determination continuous time is reset and a timer related to the no-transmission determination continuous time is commenced again.

As another example, if handover is occurred within the ISM band and interference acting on the LTE band does not occur any more, it may be determined that co-existence interference has disappeared and further detection may not be carried out.

Although in-device co-existence interference is detected in FIG. 9, a procedure of preventing delivery of interference information to the eNB can be carried out due to in-device co-existence interference. And this is intended for preventing a procedure of in-device coexistence interference varying in a random fashion from being carried out too often.

As one example, a prohibition timer can be utilized; once in-device coexistence interference is detected and interference information is delivered from the UE to the eNB, the UE is not able to deliver interference information to the eNB while the prohibition timer is operating even if in-device coexistence interference is detected again. In this way, delivery of too much interference information according to in-device coexistence interference can be prevented.

In case a situation where in-device coexistence interference last too long or a low detection rate is observed, the UE can request performing interference coordination based on the FDM technique from the eNB. This kind of request is realized by assistance information.

If in-device coexistence interference is detected, the UE transmits to the eNB assistance information for reducing, avoiding, or removing interference S905. In what follows, the operation of reducing, avoiding, or removing interference is collectively called interference coordination. Assistance information is such kind of information required for coordinating in-device coexistence interference based on the FDM technique. The eNB can regard the assistance information as a request for interference coordination. The assistance information may be a message generated in the RRC (Radio Resource Control) layer or MAC (Medium Access Control) layer or physical layer signaling.

As one example, the assistance information may include a measurement result such as SINR, RSRP, or RSRQ. As another example, the assistance information may include an indicator indicating necessity of avoiding in-device coexistence interference based on the FDM technique along with the measurement result. As another example, the assistance information may correspond to the information assisting interference coordination based on the FDM technique or the information indicating that interference coordination based on the TDM technique is impossible. In case assistance information corresponds to the information indicating that interference coordination based on the TDM technique is impossible, the assistance information can correspond to a separate indicator indicating TDM impossibility or pattern information defining a blank transmission area for the whole resources.

In the case of RSRQ, it can be obtained as an average value encompassing a particular period (for example, 200 ms). In-device coexistence interference is irregular interference occurring at different wireless systems, the average value may vary significantly depending on the situation of a device. Therefore, type of assistance information reported by the UE under the condition of in-device coexistence can be different from the assistance information of non-in-device coexistence. Assistance information reported under the condition of in-device coexistence can be classified into four types as shown below.

(1) Assistance information including a measurement result reflecting in-device coexistence interference: in this form of assistance information, in-device coexistence interference is reflected in the measurement result itself. For example, provided downlink component carriers CC1, CC2, and CC3 are configured for the UE and in-device coexistence interference occurs in CC1, RSRQ of CC1, CC2, and CC3 can be represented respectively as shown in Table 2.

TABLE 2

| CC | RSRQ |
|---|---|
| CC1 | $\frac{{S}_{1}}{{I}_{1} + {N}_{1}}$ |
| CC2 | $\frac{{S}_{2}}{{I}_{2} + {N}_{2}}$ |
| CC3 | $\frac{{S}_{3}}{{I}_{3} + {N}_{3}}$ |

Referring to Table 2, Sₙ is strength of a received signal CCₙ; In represents strength of an interference signal acting on CCₙ; and Nₙ is strength of noise acting on CCₙ (where n is 1, 2, or 3). Here, if it is assumed that strength of in-device coexistence interference is I′, a measurement result included in the assistance information is as follows.

TABLE 3

| | MEASUREMENT |
|---|---|
| CC | RESULT |
| CC1 | S₁/(I₁ + I′ + N₁) |
| CC2 | S₂/(I₂ + N₂) |
| CC2 | S₃/(I₃ + N₃) |

Referring to Table 3, Table 3 differs from Table 2 in that I′ is added to the denominator of a measurement result at CC1.

(2) Assistance information including a measurement result where RSRQ and in-device coexistence interference are separated from each other: In addition to RSRQ, strength of interference is used as a separate measurement result. In this case, the measurement result can be represented as shown in Table 4.

TABLE 4

| CC | MEASUREMENT RESULT |
|---|---|
| CC1 | $\frac{{S}_{1}}{{I}_{1} + {N}_{1}} , {I}^{′}$ |
| CC2 | $\frac{{S}_{2}}{{I}_{2} + {N}_{2}}$ |
| CC3 | $\frac{{S}_{3}}{{I}_{3} + {N}_{3}}$ |

Referring to Table 4, the measurement result about CC1 includes both of S₁/(I₁+N₁) and I′. In other words, the measurement result included in the assistance information takes the form of the existing RSRQ being added by I′.

(3) Assistance information including an usable band indicator and unusable band indicator: the CC generating in-device coexistence interference corresponds to a unusable frequency band in view of the UE. On the other hand, the CC not generating in-device coexistence interference corresponds to a usable frequency band in view of the UE. Therefore, the UE can configure assistance information comprising an usable band indicator indicating a CC belonging to a usable frequency band and an unusable band indicator indicating a CC belonging to a unusable frequency band. In the case of Table 4, the usable band indicator is {1} while the unusable band indicator is {2, 3}.

(4) Assistance information including strength of in-device coexistence interference: If in-device coexistence interference is occurred, the UE configures assistance information to display strength of in-device coexistence interference about the corresponding CC. For example, strength of in-device coexistence interference is {I′, 0, 0} and is mapped to CC1, CC2, and CC3 sequentially from the left element. Similarly, the UE can configure the assistance information in such a way that the assistance information informs of frequency band itself including a usable region and unusable region in an actual frequency band.

In the table above, the mathematical equation of SINR is a conceptual representation and used for measure signal quality due to the ratio of a signal and interference based on RSRQ. Detailed definition of RSRQ follows the LTE standard specifications.

Meanwhile, as another example, assistance information can include an indicator indicating no coexistence interference in the corresponding band (for example, a no-interference indicator). As one example, if it is determined from the procedure shown in FIGS. 12 to 14 that coexistence interference does not exist, the indicator can indicate no-coexistence interference. However, if the technical scope of the present invention is not limited to the procedure shown in FIGS. 12 to 14 and it is determined that coexistence interference is not found from other various methods, the indicator can indicate this situation. The indicator indicating no-coexistence interference can indicate no-existence of coexistence interference throughout the whole or part of frequency band. The indicator is triggered by triggering conditions determining non-coexistence interference.

Again from the step S905, the base station determines whether to carry out coordination of in-device coexistence interference according to the FDM technique based on the assistance information S910. A decision criterion for determining execution of interference coordination is as follows.

As one example, in case the type of assistance information includes a usable band indicator and unusable band indicator as shown in the case (4), the eNB can determine whether to carry out interference coordination operation based on the capacity of available resources in the avoiding band. Here, the frequency band indicated by the usable band indicator is called an avoiding band since in-device coexistence interference can be avoided there. The eNB calculates the capacity of available resources in the avoiding band. The capacity of available resources may imply the amount of wireless resources available except for the wireless resources allocated for other UEs in the avoiding band by the eNB. If the amount of available resources in the avoiding band is not enough, the eNB cannot accept mobility of the UE toward the avoiding band based on the FDM technique. On the other hand, if the amount of available resources in the avoiding band is enough (for example, more than a predetermined threshold value), the eNB can carry out interference coordination by accepting mobility of the UE toward the avoiding band.

As another example, the eNB can determine whether to carry out interference coordination operation based on a measurement result such as RSRP or RSRQ. Movement to a frequency band where RSRP or RSRQ is low may not be preferable in view of the eNB and UE. Therefore, based on determination of available resources and in view of priority order of RSRP/RSRQ, if RSRP or RSRQ value is too low, the eNB cannot accept the UE's movement to the avoiding band even if the corresponding avoiding band is found to have the capacity of available resources.

The eNB that has determined execution of coordination operation of in-device coexistence interference transmits response information to the UE S915. The response information may correspond to the information indicating acceptance or rejection of coordinating operation for in-device coexistence interference.

In case the response information corresponds to the information indicating acceptance of coordinating operation for in-device coexistence interference, the acceptance procedure for interference coordination by the eNB may correspond to any one of a cell reconfiguration procedure, handover procedure, frequency shift, and frequency shaping.

As one example, response information indicating acceptance of coordinating operation for in-device coexistence interference can correspond to a cell reconfiguration message in the cell reconfiguration procedure. If the UE receives a cell reconfiguration message from the eNB, the eNB determines that a request for coordinating in-device coexistence interference has been accepted. For example, in-device coexistence interference is detected in CC1 while CC1 and CC2 are configured for the UE, the UE can transmit assistance information for interference removal to the eNB. At this time, if CC configured for the UE is reconfigured to CC2 or CC3 according to the cell reconfiguration procedure, since CC1 that has generated interference is now removed, no further in-device coexistence interference occurs. And the UE can know from the cell reconfiguration procedure that the request for interference removal has been accepted.

As another example, response information indicating acceptance of coordinating operation for in-device coexistence interference can correspond to a handover command message is used in a handover procedure. The handover procedure performs handover of the UE to prevent occurrence of interference. If the UE receives a handover command message from the eNB, the UE can determine that a request for in-device coexistence interference has been accepted. For example, if CC1 configured for the UE is a primary serving cell (Pcell) and in-device coexistence interference is detected in the CC1, the UE can transmit assistance information for interference removal to the eNB. At this time, if the primary serving cell is changed to CC2 due to the handover procedure, no more in-device coexistence interference occurs. And the UE can know that a request for interference removal has been accepted from the handover procedure. At this time, the primary serving cell refers to a serving cell used for delivery of NAS information and security set-up when carrier aggregation is employed. According to the LTE release 10, a physical uplink control channel (PUCCH) exists in the primary serving cell and a cell consists of a pair of one DL CC and one UL CC or a single DL CC.

As another example, response information indicating acceptance of coordinating operation for in-device coexistence interference can correspond to an acceptance indicator of execution of interference coordination. The acceptance indicator can be transmitted through an RRC layer message, MAC layer message, or PDCCH of a physical layer. Likewise, the acceptance indicator can be transmitted through a new form of control message or transmitted through the message being piggybacked on different response information.

As a yet another example, response information indicating acceptance of coordinating operation for in-device coexistence interference can correspond to a frequency shift indicator indicating shift of a frequency band where interference occurs by a predetermined frequency offset or a frequency shaping indicator indicating shaping part of a frequency band where interference occurs.

In what follows, assistance information or response information used for a procedure of coordinating in-device coexistence interference as described above is collectively called “information about in-device coexistence interference”.

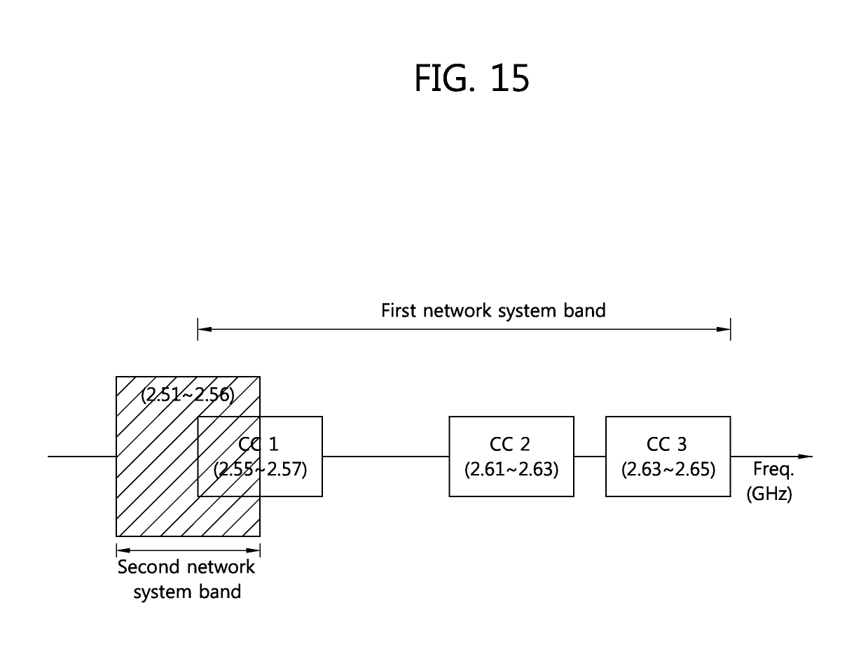

FIGS. 15 to 17 illustrate a method for carrying out controlling in-device coexistence interference according to one example of the present invention by using frequency shift or shaping.

Referring to FIG. 15, the frequency band of CC1 in a first network system ranges from 2.55 to 2.57 GHz; that of CC2 ranges from 2.61 to 2.63 GHz; and that of CC3 ranges from 2.63 to 2.65 GHz. The frequency band of a second network system ranges from 2.51 to 2.56 GHz, where CC1 of the second network system overlaps the CC1 of the first network system in the frequency range of 2.55 to 2.56 GHz. Therefore, in-device coexistence interference can occur in the range of 2.55 to 2.56 GHz. Here, the first network system can be the 3GPP (3rd Partnership Project) LTE (Long Term Evolution) system while the second network system can be Bluetooth or WiFi. If the UE transmits assistance information to the eNB due to occurrence of in-device coexistence interference, the eNB transmits to the UE response information indicating acceptance or rejection.

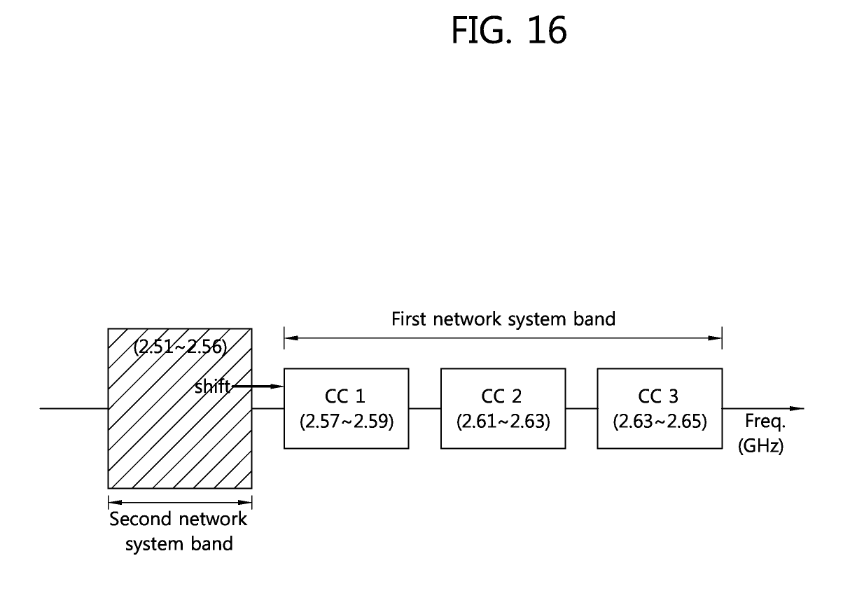

As one example, the eNB can shift a frequency band in which interference occurs, which is called frequency shift. As one example, the eNB can shift CC1 of the first network system in which interference occurs can be shifted by the offset of 0.02 GHz as shown in FIG. 16. The frequency range of CC1 is changed to the range from 2.57 to 2.59 GHz and in-device coexistence interference between CC1 and the second network system can be removed. Meanwhile, execution of frequency shift by the eNB can be notified to the UE in the form of response information, where the response information can be called a frequency shift indicator. The frequency shift indicator can be an RRC message, MAC message, or physical layer signaling.

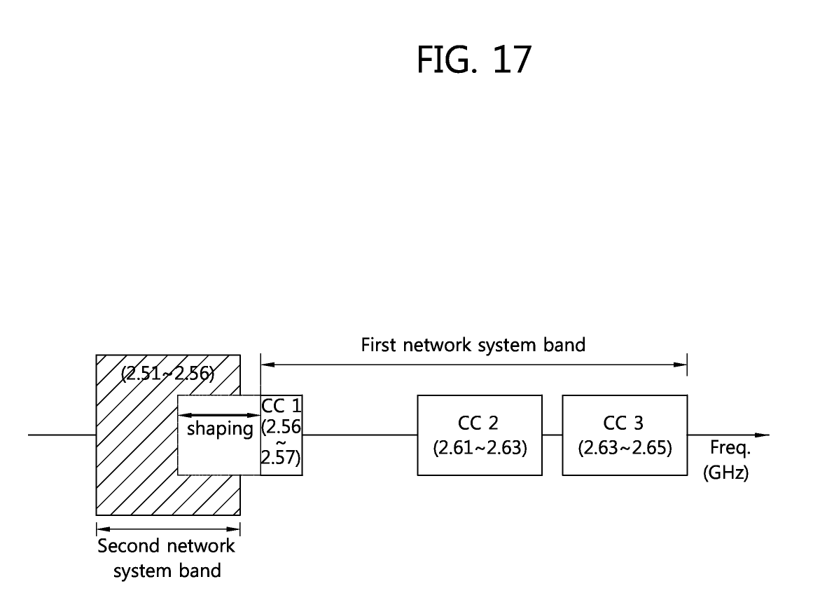

As another example, the eNB can shape a frequency band in which interference is arisen, which is called frequency shaping. As one example, the eNB can cut away the part experienced interference in the frequency band of the second network system by 0.01 GHz as shown in FIG. 17. Here, cutting away part of the frequency band can correspond to changing physical filtering characteristics (for example, the number of tabs) or correspond to the eNB's scheduling resources of the corresponding frequency band in a constrained way. In other words, resource allocation for the UE can be limited.

The frequency range of CC1 can be changed to a range of 2.56 to 2.57 GHz due to frequency shaping and in-device coexistence interference between CC1 and the second network system can be removed.

Meanwhile, the eNB informs the UE of execution of frequency shaping in the form of response information and the response information can be regarded a frequency shaping indicator. The frequency shaping indicator can be an RRC message, MAC message, or physical layer signaling.

Again, from the step of S915, in case the response information indicates rejection of coordinating operation for in-device coexistence interference, a rejection procedure due to the eNB can be any one of a reject indicator, termination of a timer, and commanding interference coordination in a different form.

(1) Transmission of a reject indicator: the eNB transmits a reject indicator as response information and carries out a reject procedure for a request for interference coordination. The reject indicator can be transmitted through an RRC message, MAC message, or PDCCH of a physical layer. Similarly, the reject indicator can correspond to a new type of indicator different from the existing message.

(2) Termination of a timer: the UE activates a timer and if the UE fails to receive response information from the eNB before the timer is terminated, it can be regarded as rejection a request for interference coordination. Here, the response information can indicate acceptance or rejection. If the UE fails to receive response information before the timer is terminated, the UE determines that a rejection procedure is carried out and performs a subsequent procedure.

(3) Commanding interference coordination in a different form: If the UE receives a message commanding interference coordination in a different form from response information expected by the UE in response to transmission of assistance information to the eNB, the UE can know that a rejection procedure based on the FDM technique is carried out. This is intended to provide an alternative solution to a situation where interference coordination based on the FDM technique cannot be carried out.

For example, if the UE receives a message indicating interference coordination based on the TDM technique, the UE can notice that even though interference coordination based on the FDM technique is turned down, interference coordination based on the TDM technique will be carried out. An indicator for interference coordination in a different form can correspond to an RRC message, MAC message, or PDCCH in a physical layer. Or indication can be realized in such a way that a TDM pattern whose interference coordination procedure itself is regarded to be relevant to the eNB is transmitted to the UE.

The rejection procedures described above can be carried out independently of each other; part of them can be carried out together; or all of them can be carried out at the same time.

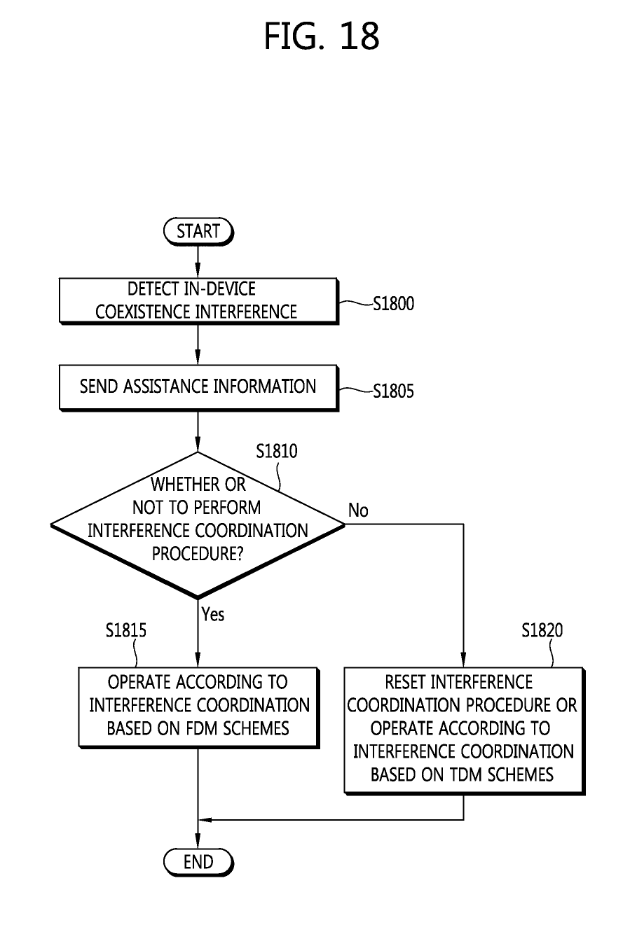

FIG. 18 is a flow diagram illustrating a method for UE transmitting information about in-device coexistence interference according to one example of the present invention.

Referring to FIG. 18, the UE detects in-device coexistence interference (S1800). When the in-device coexistence interference is detected, the UE sends assistance information to an eNB (S1805). The assistance information is information to request a kind of interference coordination, and it includes parameters necessary for the eNB to coordinate interference based on an FDM scheme. For example, the assistance information includes a measurement result, such as an SINR, RSRP, or RSRQ. For another example, the assistance information includes an indicator indicating that in-device coexistence interference based on an FDM scheme needs to be avoided along with the measurement result. The assistance information may be a message generated from an RRC layer or a MAC layer or may be physical layer signaling.

The UE determines whether or not interference coordination will be performed (S1810). Whether or not the interference coordination procedure will be performed can be determined as follows. For example, when response information indicating the acceptance of the execution of interference coordination in response to the assistance information transmitted by the UE is received, the UE can be aware that the interference coordination procedure will be performed. Here, the response information is response information in any one of a cell reconfiguration procedure, a handover procedure, a frequency shift procedure, and a frequency shaping procedure. For another example, if the UE receives an indicator indicative of interference coordination based on other schemes other than interference coordination based on the FDM scheme, the UE can be aware that the interference coordination procedure will be performed. For yet another example, if the UE does not receive response information indicative of the acceptance of the execution of interference coordination prior to the expiration of a timer after driving the timer, the UE can be aware that the interference coordination procedure request has been rejected.

If it is determined that the request for the interference coordination has been accepted, the UE operates according to interference coordination based on the FDM scheme (S1815).

If it is determined that the request for the interference coordination has been rejected, the UE resets the interference coordination procedure based on the FDM scheme or performs interference coordination based on a TDM scheme (S1820).

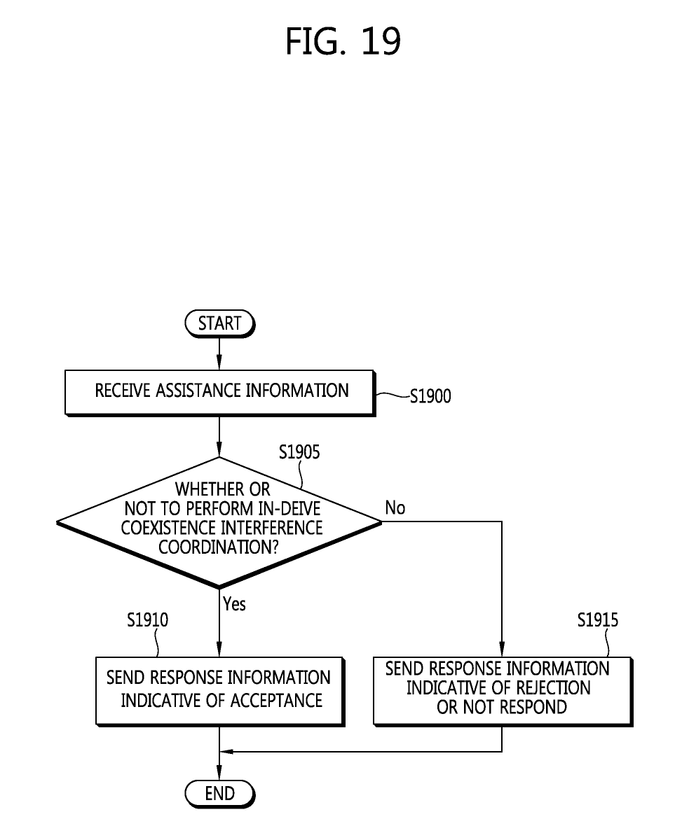

FIG. 19 is a flow diagram illustrating a method for an eNB transmitting information about in-device coexistence interference according to one example of the present invention.

Referring to FIG. 19, the eNB receives assistance information from UE (S1900). The assistance information provides information necessary to coordinate in-device coexistence interference based on an FDM scheme.

The eNB determines whether or not in-device coexistence interference based on the received assistance information can be coordinated (S1905). A criterion for the determination is as follows. For example, the eNB may determine whether or not to perform interference coordination based on the capacity of available resources in an avoidance band. To this end, the eNB can calculate the capacity of the available resources in the avoidance band and determine whether or not the capacity of the available resources in the avoidance band is sufficient. If the capacity of the available resources in the avoidance band is not sufficient, the eNB may not accept the UE moving to the avoidance band according to the FDM scheme. In contrast, if the capacity of the available resources in the avoidance band is sufficient, the eNB can accept the UE moving to the avoidance band and perform interference coordination. For another example, the eNB can determine whether not to perform the interference coordination operation based on a measurement result, such as RSRP or RSRQ. From a viewpoint of the eNB and the UE, mobility to a frequency band having low RSRP or RSRQ may not be a preferred situation. Accordingly, from a viewpoint of the determination of the capacity of available resources and priority of RSRP/RSRQ, the eNB cannot accept the mobility of the UE to an avoidance band if the avoidance band has a too low RSRP or RSRQ value although the avoidance band is determined to have the capacity of the available resources.

If it is determined that in-device coexistence interference can be coordinated, the eNB sends response information, meaning acceptance, to the UE (S1910). Here, the response information meaning acceptance can be configured in the form of any one of a cell reconfiguration message, a handover message, a frequency shift indicator, and a frequency shaping indicator.

If it is determined that in-device coexistence interference cannot be coordinated, the eNB sends response information, meaning rejection, to the UE (S1915). Here, the response information meaning rejection can be a message that orders interference coordination based on a to scheme different from an FDM scheme, such as interference coordination based on a TDM scheme, or a NACK message indicative of rejection. Or, the eNB may not send response information itself for the assistance information (no response).

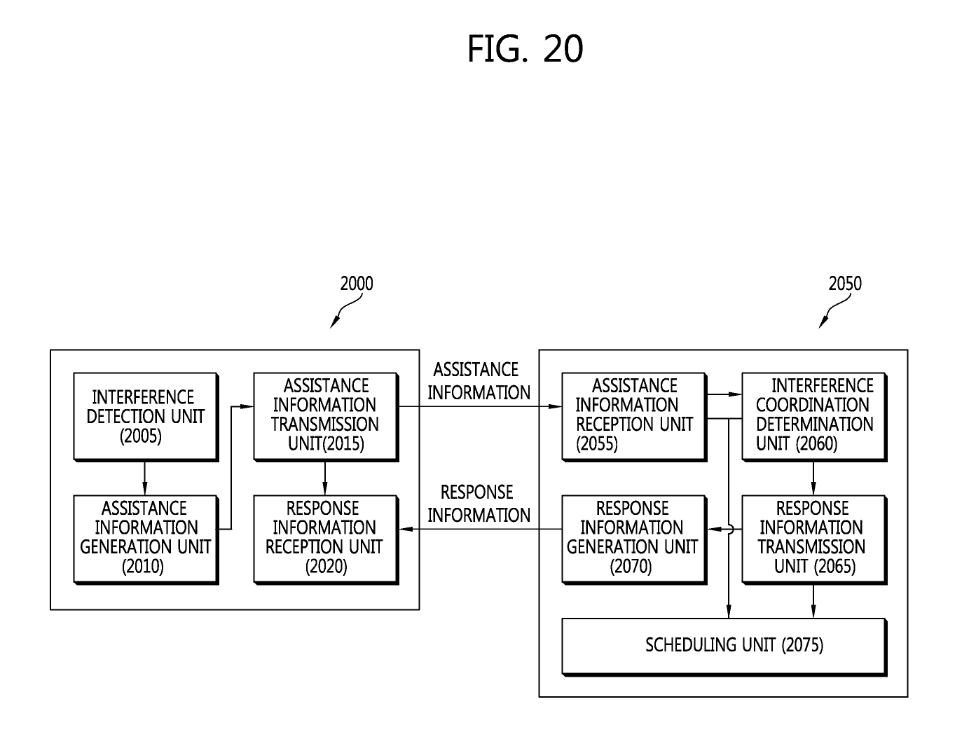

FIG. 20 is a block diagram illustrating an apparatus for transmitting and receiving information about in-device coexistence interference according to one example of the present invention.

Referring to FIG. 20, UE 2000 and an eNB 2050 exchange pieces of information about in-device coexistence interference. The pieces of information about in-device coexistence interference include assistance information transmitted by the UE 2000 and response information transmitted by the eNB 2050.

The UE 2000 includes an interference detection unit 2005, an assistance information generation unit 2010, an assistance information transmission unit 2015, and a response information reception unit 2020.

The interference detection unit 2005 detects the occurrence of in-device coexistence interference. For example, it is assumed that the UE 2000 sends a signal y through another RF, such as WiFi, while receiving a signal x from the eNB 2050 through an LTE RF. Here, if an SINR regarding the signal y exceeds a specific threshold and acts as interference with the signal x, the interference detection unit 2005 can detect the occurrence of in-device coexistence interference. Here, the interference detection unit 2005 measures the amount of interference due to the signal y and sends the result of measured interference to the assistance to information generation unit 2010. Here, an SINR has been described as an example in which the interference detection unit 2005 detects interference, but is not limited thereto. RSRP or RSRQ may be used as a criterion.

The assistance information generation unit 2010 generates assistance information based on the interference measurement result obtained from the interference detection unit 2005. For example, the assistance information includes a measurement result, such as an SINR, RSRP, or RSRQ. For another example, the assistance information includes an indicator indicating that in-device coexistence interference based on an FDM scheme needs to be avoided along with the measurement result. For yet another example, the assistance information may be information that assists interference coordination based on an FDM scheme or may be information meaning that interference coordination based on a TDM scheme is impossible. Here, if the assistance information is information meaning that interference coordination based on a TDM scheme is impossible, the assistance information may be a separate indicator indicative of TDM impossibility or may be pattern information that defines an empty transmission region for all resources.

The assistance information transmission unit 2015 sends the assistance information to the eNB 2050. Here, the assistance information transmission unit 2015 can send the assistance information through an RRC message, a MAC message, or physical layer signaling.

The eNB 2050 includes an assistance information reception unit 2055, an interference coordination determination unit 2060, a response information generation unit 2065, a response information transmission unit 2070, and a scheduling unit 2075.

The assistance information reception unit 2055 receives assistance information from the UE 2000.

The interference coordination determination unit 2060 determines whether or not to coordinate in-device coexistence interference occurring from the UE 2000. As a criterion for determining interference coordination, the interference coordination determination unit 2060 can determine whether or not to perform interference coordination based on the capacity of available resources in an avoidance band. To this end, the interference coordination determination unit 2060 can calculate the capacity of the available resources in the avoidance band and determine whether or not the capacity of the available resources in the avoidance band is sufficient. If the capacity of the available resources in the avoidance band is not sufficient, the interference coordination determination unit 2060 does not accept the mobility of the UE to the avoidance band according to an FDM scheme. In contrast, if the capacity of the available resources in the avoidance band is sufficient, the interference coordination determination unit 2060 accepts the mobility of the UE to the avoidance band and determines to perform interference coordination.

Or, the interference coordination determination unit 2060 can determine whether not to perform the interference coordination operation based on a measurement result, such as RSRP or RSRQ. From a viewpoint of the eNB and the UE, mobility to a frequency band having low RSRP or RSRQ may not be a preferred situation. Accordingly, from a viewpoint of the determination of the capacity of available resources and priority of RSRP/RSRQ, the interference coordination determination unit 2060 does not accept the mobility of the UE to the avoidance band if the avoidance band has a too low RSRP or RSRQ value although the avoidance band is determined to have the capacity of the available resources.

The response information generation unit 2065 generates response information is indicative of the acceptance or rejection of the interference coordination based on the determination of the interference coordination determination unit 2060. The response information generation unit 2065 can configure the response information in the form of any one of a cell reconfiguration message, a handover message, a frequency shift indicator, and a frequency shaping indicator. Or, the response information generation unit 2065 can generate the response information indicative of another scheme other than the FDM scheme, for example, interference coordination based on a TDM scheme.

The response information transmission unit 2070 sends the response information to the UE 2000. Here, the response information transmission unit 2070 can send the response information through an RRC message, a MAC message, or physical layer signaling.

The scheduling unit 2075 performs interference coordination based on the FDM scheme according to the determination of the interference coordination determination unit 2060. The execution of the interference coordination can be interference coordination based on cell reconfiguration, handover, frequency shift, frequency shaping, or a TDM scheme.

The above description is only an example of the technical spirit of the present invention, and those skilled in the art may change and modify the present invention in various ways without departing from the intrinsic characteristic of the present invention. Accordingly, the disclosed embodiments should not be construed as limiting the technical spirit of the present invention, but should be construed as illustrating the technical spirit of the present invention. The scope of the technical spirit of the present invention is not restricted by the embodiments, and the scope of the present invention should be interpreted based on the appended claims. Accordingly, the present invention should be construed as covering all modifications or variations induced from the meaning and scope of the appended claims and their equivalents.

1. An interference coordination method by a user equipment in a wireless communication system, comprising:
detecting interference, occurred by transmission in a first frequency band of a first network system, in receiving in a second frequency band of a second network system;
sending assistance information, assisting coordination of the detected interference, to an eNodeB (eNB); and
receiving response information which accepts or rejects the coordination of the detected interference, as a response to the assistance information from the eNB.

2. The interference coordination method of claim 1, wherein the assistance information comprises a measurement result comprising at least one of a Signal to Interference plus Noise Ratio (SINR), Reference Signal Received Power (RSRP), and Reference Signal Received Quality (RSRQ).

3. The interference coordination method of claim 2, wherein the measurement result comprises both a measurement result into which the detected interference is incorporated and a measurement result from which the detected interference has been separated.

4. The interference coordination method of claim 2, wherein the measurement result comprises strength of the detected interference.

5. The interference coordination method of claim 2, wherein the measurement result comprises an available band indicator indicative of a frequency band in which the detected interference does not occur or an unavailable band indicator indicative of a frequency band in which the detected interference occurs.

6. The interference coordination method of claim 2, wherein the assistance information further comprises an indicator indicating necessity of coordinating the detected interference based on a Frequency Division Multiplexing (FDM) scheme in which the first frequency band is separated from the second frequency band or an indicator indicating that the coordination of the detected interference is impossible based on a Time Division Multiplexing (TDM) scheme in which a reception time in the first frequency band is not overlapped with a transmission time in the second frequency band.

7. The interference coordination method of claim 1, further comprising operating a prevention timer after sending the assistance information to the eNB,
wherein if the prevention timer is running, although another interference is detected in reception in the second frequency band due to transmission in the first frequency band, assistance information assisting coordination of another detected interference is prevented from being transmitted.

8. The interference coordination method of claim 1, wherein the assistance information comprises any one of a Radio Resource Control (RRC) message, a Medium Access Control (MAC) message, and a Physical Downlink Control Channel (PDCCH).

9. The interference coordination method of claim 1, wherein the response information is received through a message used in a cell reconfiguration procedure for reconfiguring a cell or a frequency band.

10. The interference coordination method of claim 1, wherein the response information indicates shifting the first frequency band or the second frequency band by a specific frequency offset.

11. The interference coordination method of claim 1, wherein the response information is information indicating necessity of filtering some of the first frequency band or the second frequency band.

12. A user equipment performing interference coordination in a wireless communication system, comprising:
an interference detection unit which detects interference occurring in receiving in a second frequency band of a second network system due to transmission in a first frequency band of a first network system;
an assistance information generation unit which generates assistance information assisting coordination of the detected interference;
an assistance information transmission unit which sends the assistance information to an eNodeB (eNB); and
a response information reception unit which receives response information which accepts or rejects the coordination of the detected interference, from the eNB as a response to the assistance information.

13. A method of an eNodeB (eNB) coordinating interference in user equipment by in a wireless communication system, comprising:
receiving information about interference occurring in receiving in a second frequency band of a second network system due to transmission in a first frequency band of a first network system from the user equipment;
determining whether or not to coordinate the interference based on the received information about the interference; and
sending response information which accepts or rejects the coordination of the interference, to the user equipment.

14. The method of claim 13, wherein the information about the interference comprises a measurement result comprising at least one of a Signal to Interference plus Noise Ratio (SINR), Reference Signal Received Power (RSRP), and Reference Signal Received Quality (RSRQ).

15. The method of claim 14, wherein the measurement result comprises an available band indicator indicative of a frequency band in which the detected interference does not occur or an unavailable band indicator indicative of a frequency band in which the detected interference occurs.

16. The method of claim 15, further comprising calculating a capacity of available resources of an avoidance band that is a frequency band indicated by the available band indicator,
wherein whether to coordinate the interference is determined based on the capacity of the available resources of the avoidance band.

17. The method of claim 16, wherein if the capacity of the available resources of the avoidance band is a predetermined threshold or higher, the response information accepts that the user equipment moves to the avoidance band.

18. An eNodeB (eNB) performing interference coordination in a wireless communication system, comprising:
an assistance information reception unit which receives assistance information that is information about interference occurring in receiving in a second frequency band of a second network system due to transmission in a first frequency band of a first network system from user equipment;
an interference coordination determination unit which determines whether or not to coordinate the interference;
a response information transmission unit which sends response information which accepts or rejects the coordination of the interference, to the user equipment; and
a scheduling unit which performs scheduling on the coordination of the interference.
